(19) United States
(12) Patent Application Publication
(10) Pub. No.: US 2018/0014909 A1
(43) Pub. Date: Jan. 18, 2018

(54) DENTAL HANDPIECES

(71) Applicant: CAO Group, Inc., West Jordan, UT (US)

(72) Inventors: Robert K. Larsen, Riverton, UT (US); Densen Cao, Sandy, UT (US); Jack Nichols, American Fork, UT (US); Richard Bruce Draper, Sandy, UT (US)

(21) Appl. No.: 15/553,492

(22) PCT Filed: Feb. 24, 2016
(86) PCT No.: PCT/US16/19335

§ 371 Date: Aug. 24, 2017

Related U.S. Application Data
(60) Provisional application No. 61/120,685, filed on Dec. 8, 2008.

(51) Int. Cl. A61C 1/05; A61C 1/12; A61C 1/08

(52) U.S. Cl. CPC A61C 1/05; A61C 1/088; A61C 1/12

(57) ABSTRACT

A dental handpiece may comprise a head portion and a swivel portion. The head portion may include a turbine and a light guide positioned to direct light out of the head portion near the turbine. The swivel may comprise a light emitting diode (LED) positioned to direct light into the light guide and a removable battery for powering the LED.

### CROSS-REFERENCE TO RELATED APPLICATIONS

This application claims the benefit of PCT Application No. PCT/US2016/019335, filed Feb. 24, 2016, which is a non-provisional of U.S. Provisional Patent Application No. 62/120,685 filed on Feb. 25, 2015, each of which is hereby incorporated by reference in its entirety.

### TECHNICAL FIELD OF THE INVENTION

The present invention relates to dental handpieces. More specifically, the invention relates to dental handpieces that include a light emitting diode.

### SUMMARY OF THE INVENTION

Dental handpieces may comprise a head portion and a swivel portion. The head portion may include a turbine and a light guide positioned to direct light out of the head portion near the turbine. The swivel may comprise a light emitting diode (LED) positioned to direct light into the light guide and a removable battery for powering the LED.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which advantages and features of the invention can be obtained, a description of the invention will be rendered by reference to specific example embodiments thereof which are illustrated in the appended drawings. Understanding that these drawings depict only typical implementations of the invention and are not therefore to be considered to be limiting of its scope, the invention will be described and explained through the use of the accompanying drawings.

FIG. 1 shows an exploded view of a dental handpiece according to an embodiment of the present invention.

FIG. 2 shows a cross-sectional view of the dental handpiece of FIG. 1.

### DETAILED DESCRIPTION

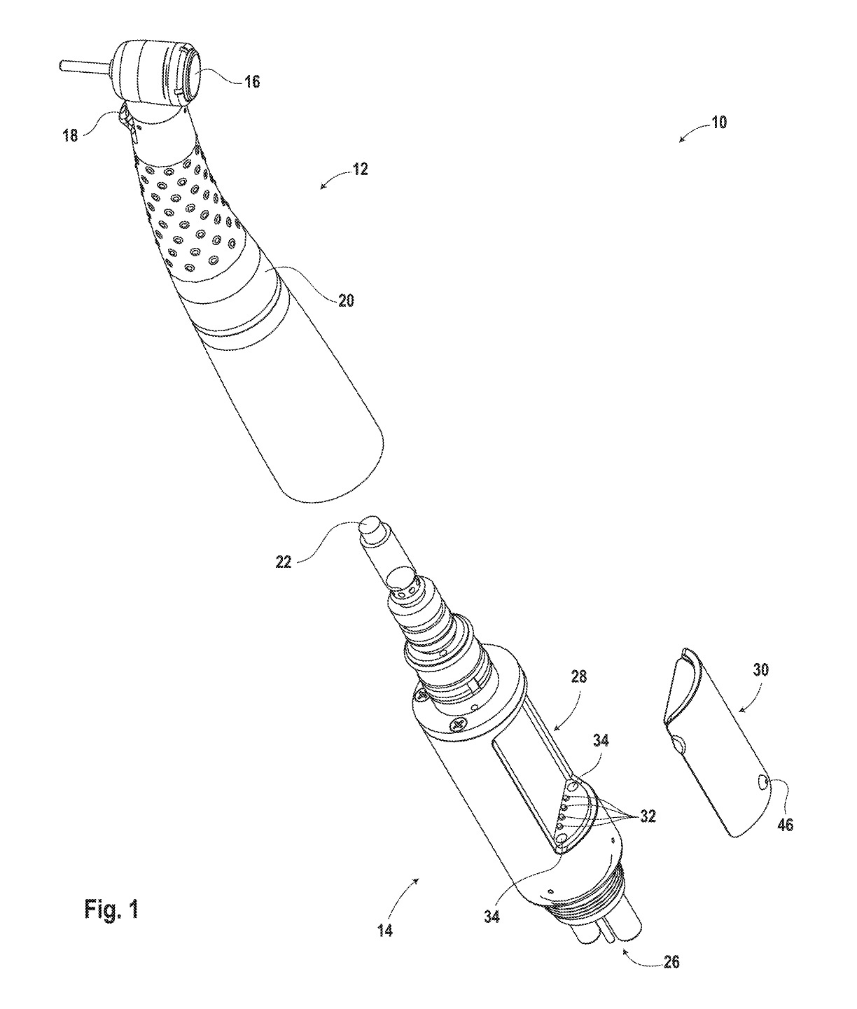

An exploded view of a dental handpiece 10 according to an embodiment of the present invention is shown in FIG. 1. The dental handpiece 10 includes a head portion 12 and a swivel portion 14. The head portion 12 may be attachable and detachable from the swivel portion 14 and may rotate freely relative to the swivel portion 14 when attached thereto. The swivel portion 14 may be configured to attach to a conventional air and water supply.

The head portion 12 of the dental handpiece 10 may include a turbine 16 at one end and a light guide exit 18 may be positioned proximate to the turbine 16, so that a work surface may be illuminated by light emitted from the light guide exit 18. A main body 20 of the head portion may be made from a material that may withstand autoclaving, such as stainless steel, aluminum or a temperature resistant polymer such as polyether ether ketone (PEEK).

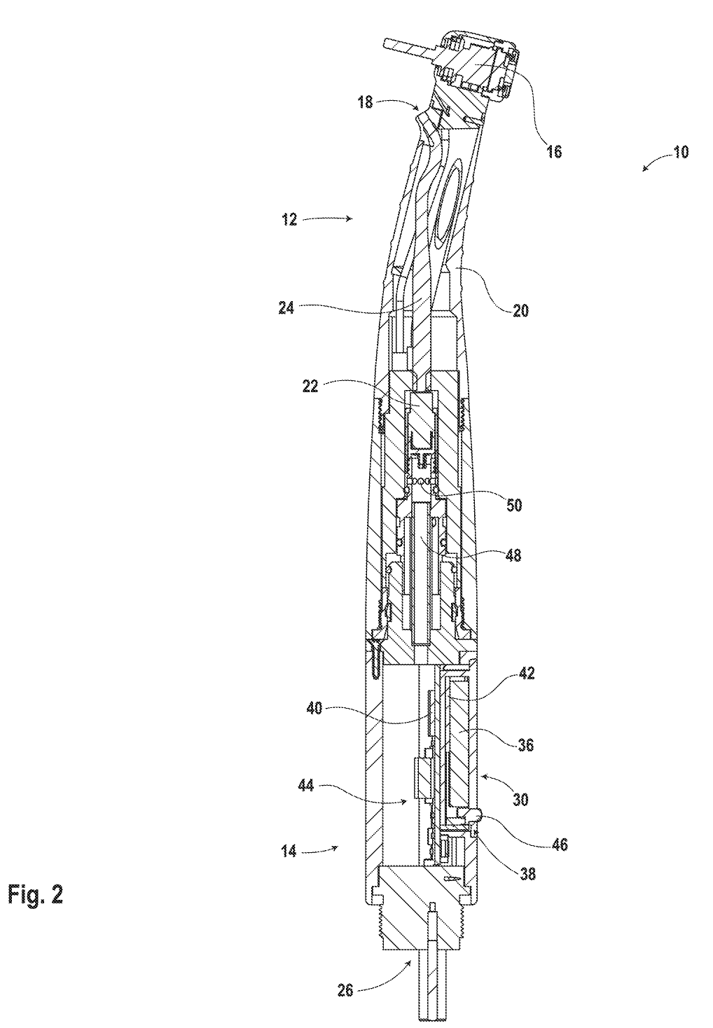

The swivel portion 14 of the dental handpiece 10 may include a light emitting diode (LED) 22 at a first end positioned to direct light into a light guide 24 (see FIG. 2) of the head portion 12 when coupled thereto. A second end of the swivel portion 14 may include a coupler 26 for attaching an air and water supply to the dental handpiece 10.

A cavity 28 formed in the swivel portion 14 may be sized and configured to receive a battery unit 30 therein. Located within the cavity 28 may be a plurality of electrical contacts 32 for electrically connecting with corresponding electrical contacts located on the battery unit 30. Additionally, the cavity 28 may include apertures 34 for receiving corresponding protrusions on the battery unit 30, which may facilitate the securing of the battery unit 30 to the swivel portion 14 of the dental handpiece 10.

As shown in FIG. 2, the battery unit 30 may include a rechargeable battery 36 therein, an activation switch 38 for activating the battery unit 30. When the battery unit 30 is installed into the cavity 28 of the swivel portion 14, a magnet 40 positioned in the swivel portion 14 may magnetically attract a metal plate 42 located within the battery unit 30 to maintain the battery unit 30 in the cavity 28 until sufficient force is applied to the battery unit 30 to overcome the magnetic force and remove the battery unit 30.

Control circuitry 44 may be located between the battery 36 and the LED 22. The control circuitry 44 may be located within the battery unit 30, may be located within the swivel portion 14, or a portion may be located in the battery unit 30 and a portion may be located within the swivel portion 14, as shown.

The control circuitry 44 may include the actuation switch 38, a timer, an accelerometer, a second switch, and a capacitor. When both the activation switch 38 and the second switch are closed, power will be directed to the capacitor and then to the LED 22. The actuation switch 38 may be closed by an operator depressing a button 46 located on the battery unit 30. The actuation switch 38 will remain closed for a specific time following the sensing of no motion from the accelerometer, after which the timer will cause the actuation switch to be opened. The second switch will be closed in response to motion sensed by the accelerometer, and will be opened if there is no motion sensed by the accelerometer. After the opening of the actuation switch 38 and/or the second switch, the LED 22 will no longer receive power from the batter, but will receive power from the capacitor for a moment until the capacitor is discharged.

Accordingly, after an operator presses the button 46 to close the actuation switch 38, the LED 22 will be powered and provide illumination while the operator is using the dental handpiece 10. The LED 22 will automatically shut off, slowly fading due to the capacitor, after the handpiece 10 has been set down and remains unmoved for a period of time.

As shown in FIG. 2, the LED 22 and an end of the light guide 24 proximate to the LED 22 may be positioned at the rotational axis of the head portion 12 relative to the swivel portion 14 of the handpiece 10. This configuration allows the LED 22 to emit light into the light guide 24 no matter which rotational orientation the head portion 12 is relative to the swivel portion 14. To facilitate the location of the LED 22 at the rotational axis, air that is directed through a channel 48 that is located at the rotational axis in the swivel portion 14 is directed radially outward through openings 50 at a location intermediate the LED 22 and the second end of the swivel portion 14 and into an annular cavity formed between the swivel portion 14 and the head portion 12. From the annular cavity, the air is then directed to the turbine 16 through a channel in the head portion 12 that is located away from the rotational axis.

The present invention may be embodied in other specific forms. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dental handpiece comprising:
a head portion, the head portion comprising:
a turbine; and
a light guide positioned to direct light out of the head portion near the turbine;
and
a swivel comprising:
a light emitting diode positioned to direct light into the light guide; and
a removable battery for powering the light emitting diode.
